(19) United States
(12) Patent Application Publication
(10) Pub. No.: US 2025/0047371 A1
(43) Pub. Date: Feb. 6, 2025

(54) SATELLITE OPERATIONS

(71) Applicant: ICEYE OY, Espoo (FI)

(72) Inventor: Pekka Tuomas Laurila, Espoo (FI)

(73) Assignee: ICEYE OY, Espoo (FI)

(21) Appl. No.: 18/712,557

(22) PCT Filed: Nov. 10, 2022
(86) PCT No.: PCT/EP2022/081544

§ 371 Date: May 22, 2024

(30) Foreign Application Priority Data
Nov. 24, 2021 (GB) 2116902.4

(51) Int. Cl. H04B 7/185

(52) U.S. Cl. CPC H04B 7/18521; H04B 7/18513

(57) ABSTRACT

A method of providing Earth observation data comprises: acquiring Earth observation echo data on a first satellite in a low Earth orbit, determining a time required to downlink predetermined data to a ground station on Earth from the first satellite at the current position of the first satellite. If the time required exceeds a predetermined threshold, the predetermined data may be transmitted to another satellite in orbit above Earth using space-to-space radio communication. Alternatively, the first satellite may receive data relating to the current position of another satellite in orbit above Earth, determine a time required to the predetermined data to a ground station via the other satellite at the current position of the at least one other satellite, and if the determined time for the other satellite is less than the time determined for the first satellite, transmit the predetermined data to the other satellite in orbit above Earth using space-to-space radio communication.

In some possible implementations, the echo data may be processed on-board the first satellite to generate an image and analysed to determine a portion of interest. Then the predetermined data may comprise a data structure comprising a location of the portion of interest which may be transmitted using the space-to-space link.

The present application relates to processing and delivery of Earth observation satellite data products.

### BACKGROUND

Many land and maritime monitoring applications such as detection and tracking of ships, land vehicles, deforestation and mining activities require up-to-date surveillance information for the purpose of tracking events on Earth. For this purpose, surveillance images can be acquired by Earth observation satellites that pass over a location of interest. However, the process of returning Earth observation data to Earth takes time and limits how up-to-date the information is when it is provided to the end user. This causes problems for some surveillance applications where recent information is required.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter.

The present disclosure provides an earth observation satellite and method of providing Earth observation data that may use a space-to-space link to transmit observation echo data.

In a first aspect, the present disclosure provides methods of providing Earth observation data comprising: acquiring Earth observation echo data on a first satellite in a low Earth orbit, determining a time required to downlink predetermined data to a ground station on Earth from the first satellite at the current position of the first satellite.

If the time required exceeds a predetermined threshold, the predetermined data may be transmitted to another satellite in orbit above Earth using space-to-space radio communication.

Alternatively, the first satellite may receive data relating to the current position of another satellite in orbit above Earth, determine a time required to the predetermined data to a ground station via the other satellite at the current position of the at least one other satellite, and if the determined time for the other satellite is less than the time determined for the first satellite, transmit the predetermined data to the other satellite in orbit above Earth using space-to-space radio communication.

In a second aspect, the present disclosure provides an Earth observation satellite configured for implementing any of the methods described here. The satellite may comprise sensors configured to collect the echo data and a radio transmitter configured to transmit a portion of the echo data to another satellite using a space-to-space link.

In some possible implementations, the echo data may be processed onboard the first satellite. For example the echo data may be processed to generate an image and analysed to determine a portion of interest. Then the predetermined data may comprise a data structure comprising a location of the portion of interest which may be transmitted using the space-to-space link. Alternatively the predetermined data may comprise at least a portion of the acquired echo data.

There is also provided here a method of providing Earth observation data comprising acquiring Earth observation echo data at a satellite in orbit above earth, processing the echo data at the satellite to generate an image; analysing the image at the satellite to determine a portion of interest; and transmitting a data structure comprising a location of the portion of interest using a space-to-space link to another satellite.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The features described in the following may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of typical acquisition and delivery to Earth of Earth observation data;

FIG. 2 is a schematic diagram of near-real-time acquisition and delivery to Earth of Earth observation data according to an approach similar to that of FIG. 1;

FIG. 3 is a schematic diagram of an example Earth observation satellite;

FIG. 4 is a schematic diagram of an example approach to providing Earth observation data;

FIG. 5 is a flow chart of an example method of providing Earth observation data;

FIG. 6 is a flow chart of an alternative example method of providing Earth observation data; and

FIG. 7 is a schematic diagram of hardware for implementing the methods described here.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

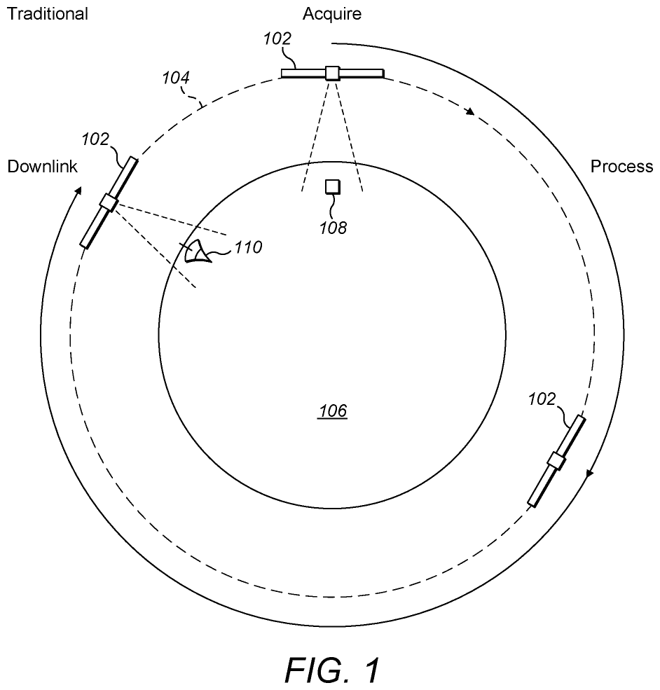

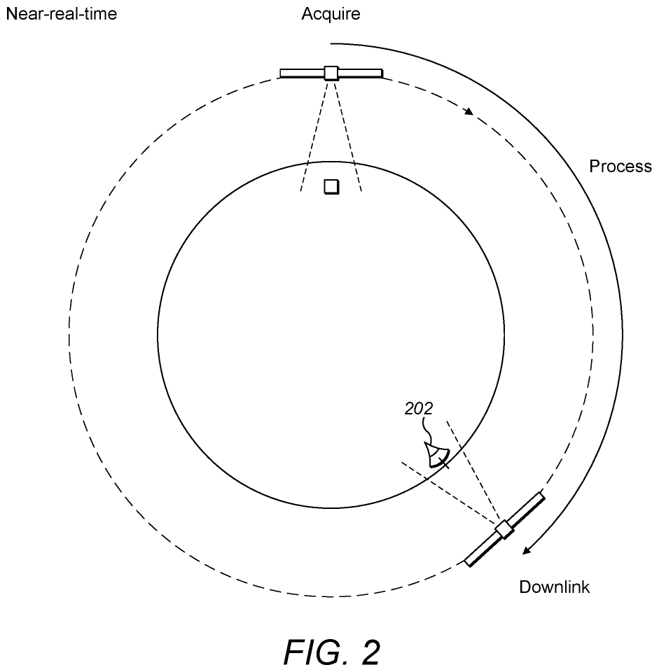

FIGS. 1 and 2 illustrate a typical Earth observation satellite 102 in orbit 104 around Earth 106. In this document the term ‘satellite’ is to be interpreted broadly to include all classes of satellites, such as Earth observation satellites, communications satellites and geostationary satellites, as well as space stations, spacecraft and aircraft. In the following, some embodiments are described in which images are obtained using synthetic aperture radar or “SAR”. The Earth observation satellite 102 of FIG. 1 is thus configured to acquire echo data when it passes over a location 108 for the purposes of imaging the location 108 and delivering imaging data, e.g. raw echo data, to a ground station 110 on Earth 106. Computing systems at the ground station may then process the imaging data in various ways including using the data to generate images of areas on Earth from space. Information derived from the raw data such as the images may then be transmitted to end users. One ground station 110 is shown in the figures but in a practical implementation an earth observation system may include multiple ground stations and multiple satellites. In some implementations, the raw data may be transmitted to cloud computing infrastructure, e.g. from a ground station, and processed further in cloud services.

Current earth observation methods from satellites cannot provide instantaneous response for detection services. The fastest possible times are achieved when a ground station 110 is available to a satellite 102 for “direct downlink”, i.e. the echo data is collected while over the horizon of a ground station, in other words the satellite 102 has line of sight to a ground station 110.

It usually takes between 20-60 minutes to complete a ‘near-real-time’ acquisition and processing chain for an urgent Earth Observation data product. An example is a case of ship detection, where satellite radar imagery would be acquired to detect vessels on sea and this information would be required immediately to find the vessel in question for interception purposes. For example, downlink of raw echo data can take 5 minutes, processing into an image at the ground station may take 5 minutes, analysis of the image may take 10 minutes and various tasks of storing and uploading the result data through ground networks to customer systems can take another 15 minutes, totaling 35 minutes.

More usually there is a further delay while the satellite 106 waits to pass over a first available ground station 110. A typical delay may be as much as 45 minutes or more before the satellite 102 is within a direct link horizon of a ground station 110 and can downlink the raw data to Earth 106. Combined with the processing time on Earth of around 30 minutes, a 45 minute delay for downlink would mean that the data is already 75 minutes old when it arrives at the customer.

These scenarios are illustrated in FIGS. 1 and 2. In FIG. 1 the satellite 102 has line of sight to the ground station 110 and is able to transmit raw data to the ground station 110 relating to the location 108.

As noted above, it is unusual that a satellite would happen to pass over a ground station that can provide a downlink immediately after acquisition of echo data. It is more likely that there would be some delay in reaching an orbital position where there is a direct line of sight to a ground station. This scenario is illustrated in FIG. 2 where the satellite has to travel some distance around the earth before it has line of sight to a ground station.

In some situations it might be economically justified to build a ground station in a location to provide a direct downlink as soon as data is acquired, but this is generally only practical when a fixed location is to be monitored periodically. In general this is not a viable solution, and would not be suitable if the location changed or images of a new location were required urgently. It is also unlikely to be suitable when the location of interest is at sea. Furthermore, satellite operators typically “rent” time in existing ground stations in order to communicate with their satellites. In other words, satellite operators do not necessarily have control over the location of ground stations, and the number of ground stations available for downloading data from satellites is limited.

Some of the methods described here use a space-to-space link for the purpose of transmitting Earth observation data to ground. Before transmitting data via a space-to-space link, a time required to downlink predetermined data from the satellite to a ground station on Earth may be determined. The predetermined data may comprise at least a portion of Earth observation echo data acquired by the satellite. Alternatively as described further below it may comprise a data structure derived from processing and analysis of the echo data on-board the satellite.

The required downlink time would include the time it takes for the satellite to come within line of sight of the ground station. This could be determined from information available on-board the satellite such as GPS sensor information and ground station locations.

The next operation may depend on the space-to-space link to be used. For example if the data is to be transmitted via a higher earth orbit it might be assumed that it would be faster than a predetermined time and hence used if the determined time exceeds that. Alternatively, as explained further below, the satellite might have knowledge of the position of at least one other satellite, for example satellites in the same constellation may share location information, in which case a time may be determined for at least one other satellite and this may be used if the time is shorter. It should be noted that the determined time for another satellite may allow for multiple space-to-space “hops”.

Traditionally, very little or no processing of raw data has taken place at the satellite. Satellites have been designed largely for reliability and longevity. As a result they have been provided with extremely robust computing electronics, at the expense of performance. Hence satellites have not been provided with the computing power to process the raw data and all of the processing has taken place at ground stations.

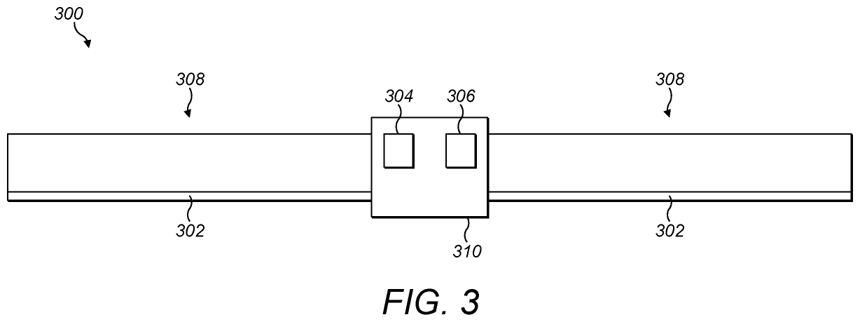

Referring to FIG. 3, an example Earth observation satellite 300 such as a synthetic aperture radar (SAR) satellite may be used in a different approach. Some embodiments of the invention use processing of the raw data at the satellite combined with the use of one or more space-to-space communication links to improve the speed at which information derived from the raw data can be delivered to users.

As shown, the satellite 300 comprises sensors 302 configured to collect echo data, a computing system 304 configured to process the echo data to generate an image and to analyse the image to determine a portion of interest., A transmitter 306 is configured to transmit a data structure comprising a location of the portion of interest using a space-to-space link. A space-to-space link is a communication link between two launched satellites, satellites being interpreted according to the above definition. The sensors 302 may include one or more radar transceivers or optical transceivers for collecting echo data reflected from Earth, and the sensors 302 may be mounted on or housed in one or both of two generally planar structures 308 of the satellite 300. The generally planar structures 308 are referred to in the art as ‘wings’, although it will be appreciated that the wings 308 of the satellite 300 do not have the same requirements for aerodynamic performance as, for example, aircraft wings. The computing system 304 comprises a processor for processing the echo data and for performing image analysis, and memory storing instructions for the processor. The transmitter 306 may comprise a radio transmitter for transmitting a data structure to another satellite such as a telecommunications satellite or to another spacecraft such as a space station using radio signals. The computing system 304 and transmitter 306 may be mounted on or housed in a satellite body 310 from which the wings 308 extend. In another example, the transmitter 306 may be mounted on or housed in one or more of the wings 308.

Thus instead of transmitting raw data, or information derived from image processing, directly to a ground station, a satellite according to some embodiments is able instead to transmit to another satellite that might have line of sight to a ground station, or be closer to being able to downlink the information to a ground station. The other satellite may be in the same or a similar orbit, e.g. low earth orbit. Alternatively the other satellite may be in a higher earth orbit. Systems are available for communication between satellites including terminals for small satellites for data link over medium earth orbit satellite phone constellations such as Iridium or Inmarsat. The type of hardware used for software radios may be used for this purpose.

The satellite 300 may include a variety of other components. For example, one or more solar panels may be mounted on or housed in one or more of the wings 308 and/or the body 310 to provide a power supply for other components. At least one power storage device such as a battery may be mounted on or housed in one or more of the wings 308 and/or the body 310 to enable the satellite to operate in low sunlight conditions. At least one transceiver for communicating with ground stations may be mounted on or housed in one or more of the wings 308 and/or the body 310, and/or the transmitter 306 may be part of a transceiver configured to communicate with other satellites and with ground stations. The satellite 300 may also comprise systems not described further herein such as but not limited to a heat control system, an attitude control system to ensure that the satellite 300 points in the correct direction, and a propulsion system.

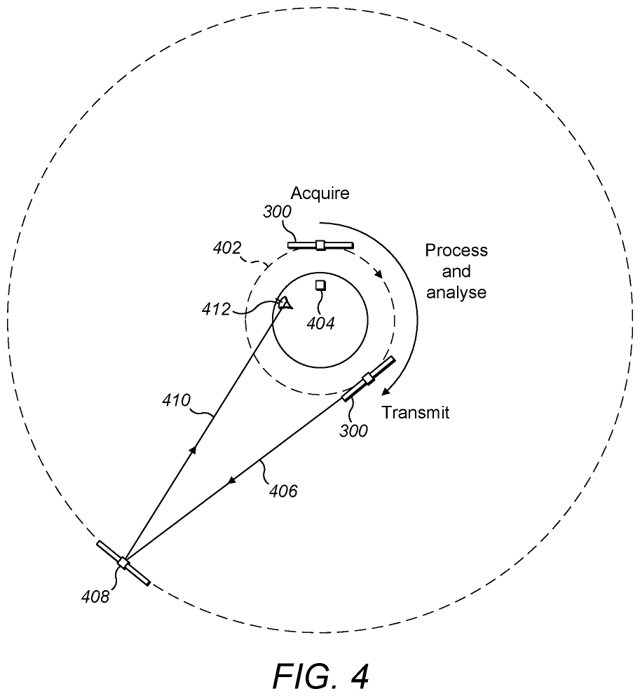

FIG. 4 shows the satellite 300 in a low Earth orbit 402. The satellite 300 may be used to acquire an image of a location 404 on Earth, to process the image on-board, and to provide data derived from the image to Earth using a space-to-space link 406.

Raw echo data collected by radar or optical sensors 302 of the satellite 300 is processed on-board the satellite 300 using the satellite's computing system 304. The computing system 304 may suitably comprise a central processing unit (CPU) and/or a field-programmable gate array (FPGA) for processing the raw echo data. Using a FPGA can provide for faster processing than a normal CPU processor. The echo data is processed to generate an image of the location 404 by mapping contours of the Earth and objects on its surface using the timing of echo signals received by the sensors 302.

Raw echo data collected by the radar or optical sensors 302 of the satellite 300 are processed on-board the satellite 300 by its computing system 304 to generate an image of the location 404 based on contours determined using the timing of received echo signals. The satellite's computing system 304 which may comprise a central processing unit (CPU) and/or a field-programmable gate array (FPGA) for processing the raw echo data.

The image may then be analysed to determine a portion of interest. The analysis operation is performed on-board the satellite 300 by its computing system 304 and may be used to detect various objects or changes occurring on the Earth's surface that are of interest for monitoring applications.

For example, the analysis operation may comprise using an object detection algorithm such as a neural network based object detection algorithm to detect an object on the Earth's surface. This may be useful, for example, in ship detection and/or tracking applications where ships need to be detected and/or identified. If a neural network is used, it may suitably comprise a classifier to classify an object into predefined classes. For example, a classifier may be used to classify ships into predefined types of ships. In this case, the neural network may be trained on ground in a computing intensive training process, but contextual data may be uplinked to the satellite 300 to augment the data set and/or add extra layers to the neural network. In this case, further training may be performed on-board the satellite using the uploaded data, which may include data such as images of ships, ship historic routes and so on. In this or other cases, a threshold confidence level of the detection algorithm may be selected to ensure that although some false positives may be detected it is likely that all genuine objects of interest will be detected. In the case of object detection, the portion of interest of the image may comprise at least part of a detected object.

Additionally or alternatively, the analysis operation may comprise using a change detection algorithm to detect a change such as deforestation or changes resulting from mining activities, or a change such as the movement of an object. In an example, the change detection algorithm may be configured to detect changes using pixel mathematics. The change may be detected by reference to another image of the same location taken at a previous time, possibly by the same satellite 300 or a different satellite, and may in some examples have been provided to the satellite 300 by being uploaded from a ground station or transmitted from another satellite. Alternatively or additionally, the change may be detected by reference to data derived from another such image, possibly taken by the same or a different satellite, and in some examples provided by transmission from a ground station or another satellite. In the case of change detection, the portion of interest of the image may comprise at least part of an area on Earth that has undergone a change.

Object or change detection on-board the satellite 300 may be facilitated by uploading other information to the satellite 300 such as water-mask information to define coastlines and other areas of water such as rivers and lakes, land use classification information such as boundaries between agricultural areas and urban areas or boundaries between countries or private ownerships, facility locations, parking lot boundaries, and so forth. For example, such information may be utilised to provide more context in the case of neural network based object detection.

Additionally or alternatively, a characteristic, type or identity of the portion of interest may be performed on-board the satellite 300. For example, in the case of object detection, the satellite's computing system 304 may be configured to detect an object characteristic such as a size of a ship, an object type such as a type of ship, or an object identity such as a unique identity of a ship. This functionality may suitably be provided by the object detection algorithm. In the case of change detection, the computing system 304 may be configured to detect a change characteristic such as a rate of deforestation, or a change type such as deforestation or mining.

The satellite's computing system 304 may be configured to assemble a data structure for transmission. The data structure may comprise any of a location of the portion of interest, a characteristic, type or identity of the portion of interest, and a snippet of the image comprising at least part of the portion of interest. For example, in the case of object detection, the data structure may comprise any of a location of a detected object, a characteristic, type or identity of the detected object, and a snippet of the image comprising at least part of the object of interest. In this case, the snippet may additionally include immediate surroundings of the detected object. In the case of change detection, the data structure may comprise any of a location of a detected area of change, a characteristic or type of the detected change, and a snippet of the image comprising at least part of the area of change. The location of the portion of interest may be described in coordinates such as longitude and latitude coordinates. If more than one portion of interest is detected in an image, then information relating to each respective portion of interest may be included in the data structure.

Although a snippet comprising a portion of interest may be included in the data structure, it will be appreciated that at least a majority of the image is not included in the data structure. As a result, the data structure may be significantly smaller than the image, for example one or more orders of magnitude smaller than the image. The reduction in the amount of data is useful for radio transmission.

The computing system 304 provides the data structure to the transmitter 306 of the satellite 300 for radar transmission via a space-to-space link. The data structure may be transmitted to another low Earth orbit satellite such as another Earth observation satellite, or any other suitable satellite, for example a communications satellite of a telecommunications network which may be in a medium Earth orbit. In the example of FIG. 4, the transmitter 306 transmits the data structure using space-to-space link 406 to a communications satellite 408 in a medium Earth orbit for onward transmission to Earth. The communications satellite 408 transmits the data structure via a direct downlink 410 to a ground station 412 on Earth. In other examples, the communication channel from the satellite 300 to Earth may comprise two or more space-to-space links.

Space-to-space communication is useful when the satellite 300 is ready to transmit the data structure but is not within a direct link horizon of a ground station 404. Traditionally, space-to-space data links are too slow to support image data downlinks on a reasonable timeframe. However, the reduced amount of data in the data structure according to some examples can help enable space-to-space transmission because the amount of data may be reduced by one or more orders of magnitude. For example, the data structure may be three orders of magnitude smaller than the image. When the satellite 300 is not within a direct link horizon of a ground station, space-to-space communication enables the reduced size data structure to be downlinked to Earth immediately, or sooner, at a rate that enables an acceptable delivery time. In an example, if the data structure is three orders of magnitude smaller than the image, then it may be possible to downlink the data structure to Earth using space-to-space communication in approximately 10 seconds. In this case, information contained in the data structure such as locations and types of detected objects can be delivered to Earth and to an end user without delay. By contrast, it could take around two hours to downlink an image to Earth using space-to-space communication.

Tasking of the satellite 300 to command it to acquire images of locations on Earth may also be performed using space-to-space links, for example using one or more satellites of a telecommunications network. Commands require little data, so this can be achieved in a very reasonable amount of time. Using space-to-space communication for both tasking the imaging satellite 300 and downlinking the data structure makes the full chain of events independent of the imaging satellite's direct access to ground stations. As a result, there is a significantly reduced delay between receiving a request for information from an end user and delivering the information in the data structure to the end user compared with traditional methods that rely on a direct link between the imaging satellite 300 and a ground station.

The remaining image data that was not transmitted in the data structure can be downlinked to Earth using a traditional direct link when the satellite 300 is within a direct link horizon of a ground station. This may be useful to build up an image archive for further analysis, for example to provide context for object detection or change detection algorithms.

The delay between receiving a request for information from an end user and delivering the information in the data structure to the end user can be reduced further by providing a plurality of imaging satellites 300 in orbit so that at any time there is not a long wait before an available imaging satellite 300 passes over a location to be imaged. In this case, the request from the end user may be tasked to an appropriate one of the satellites 300 to image the location with minimal delay. Such an arrangement using a plurality of satellites 300 helps to keep the delay consistently low.

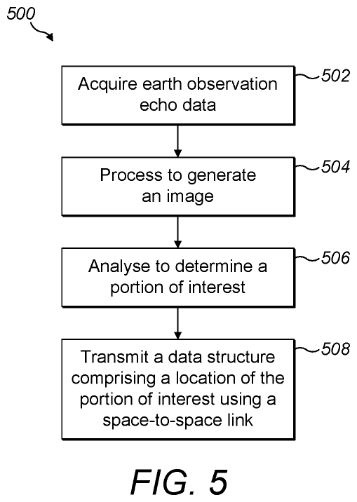

Referring to FIG. 5, a satellite may perform a method 500 to provide Earth observation data. The method 500 comprises acquiring 502 Earth observation echo data and processing 504 the Earth observation echo data to generate an image. The method 500 further comprises analysing 506 the image to determine a portion of interest, and transmitting 508 a data structure comprising a location of the portion of interest using a space-to-space link. The space-to-space link forms part of a communication channel to Earth.

A satellite may perform a series of operations in order to decide whether or not to use a space-to-space link for communicating information to a ground station. This may be used for the communication of any data to a ground station and is not limited to the data structure described elsewhere here. Nevertheless such operations are particularly useful for the transmission of such a data structure.

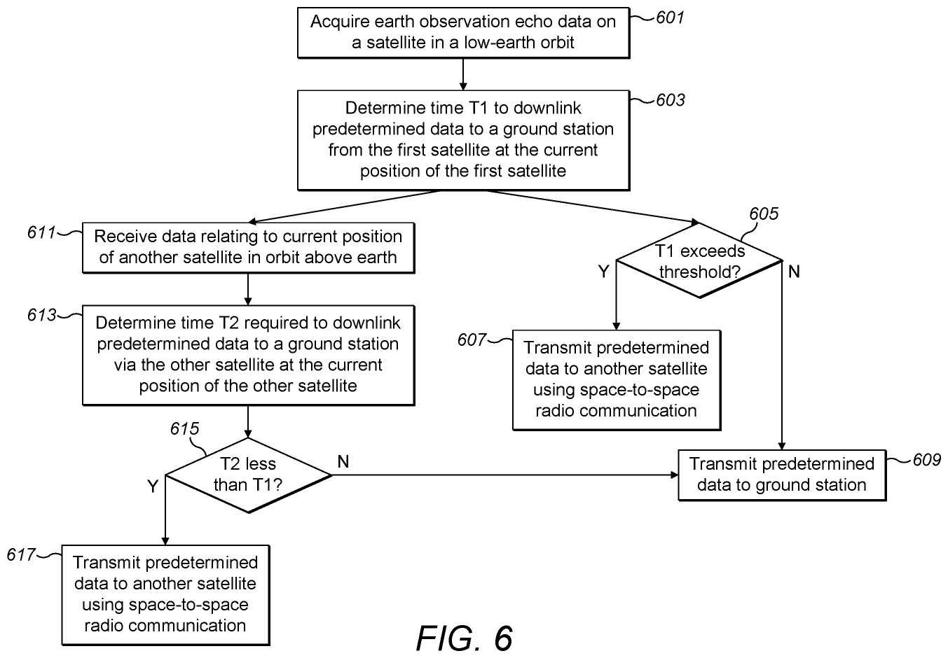

A series of operations is shown in FIG. 6. At operation 601 earth observation data is acquired by a satellite in low earth orbit. Then at operation 603 a time T1 is determined being the time required to downlink predetermined data to a ground station from the satellite at its current position. The predetermined data may comprise a data structure as described elsewhere here or it may comprise at least a portion of acquired echo data. The time determined at operation 603 may depend on the nature or quantity of the predetermined data.

Then, in one optional series of operations, a decision is made at 605 whether the time T1 exceeds a predetermined threshold. If so, the predetermined data is automatically transmitted to another satellite using space-to-space radio communication. This other satellite may be a satellite known to the satellite acquiring the data to have the capability to downlink the data within a shorter time than T1. An example of such another satellite may be a satellite in a higher orbit that has line of sight to a larger area of the earth and is therefore more likely to have line of sight to a ground station.

The time T1 may be suitably chosen to ensure that another, for example predetermined, satellite is able to downlink the data to Earth in a time shorter than T1. In the case of a LEO constellation the threshold might be determined based on knowledge of the constellation so that there is bound to be another route to ground that is faster provided that the threshold is suitably chosen.

If T1 does not exceed the threshold then the predetermined data is transmitted directly to the ground station at operation 600, for example as soon as the satellite acquiring the echo data has line of sight to a ground station.

In an alternative series of operations to 605 and 607, the satellite acquiring the echo data may receive data relating to the current position of another satellite in orbit above Earth at operation 611 and determine a time T2 required to downlink predetermined data to a ground station via the other satellite at the current position of the other satellite. The downlink may be direct from the other satellite or it may be via a third satellite. In other words there is no limit to the number of space-to-space “hops” that might be used to downlink data to a ground station. A decision is made in operation 615 whether T2 is less than T1. If so the data is transmitted to the other satellite using space-to-space radio communication. Otherwise the process continues to operation 609. This series of operations does not use a threshold time for downloading data to Earth and may therefore allow for faster downlinking of data.

It will be appreciated that operations 611, 613 and 615 may be repeated for multiple other satellites and combinations of multiple space-to-space links before a decision is made to transmit the predetermined data from the ground station. For example operations 611, 613, 615 may be repeated in this way until the satellite that acquired the Earth observation data has travelled to a position where it has line of sight to a ground station which is configured to receive or capable of receiving data from it.

So in some implementations a satellite that has acquired echo data may receive data relating to the current position of multiple other satellites in low earth orbit and select one to which data will be transmitted via a space-to-space link. The selection may be based on current position, or a downlink time may be determined for multiple satellites and the fastest may be selected.

Any of the methods described here may include an additional step of determining whether the satellite acquiring the echo data has line of sight to another satellite and/or is configured to communicate with another satellite to which it has line of sight.

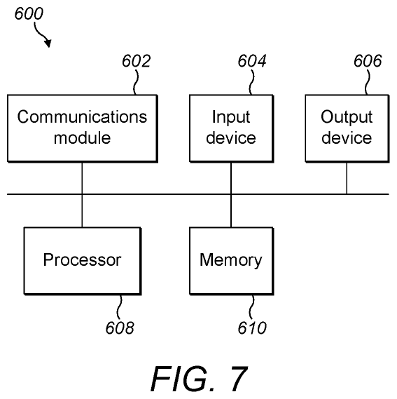

Referring to FIG. 7, a satellite may comprise hardware 600 to perform the method 500. The hardware 600 comprises a communications module 602, an input device 604 such as a receiver, an output device 606 such as a transmitter, a processor 608, and a memory 610. The memory 610 may store code encoding instructions that, when executed by the processor 608, cause the satellite to perform the method 500.

In the embodiment described above the server may comprise a single server or network of servers. In some examples the functionality of the server may be provided by a network of servers distributed across a geographical area, such as a worldwide distributed network of servers, and a user may be connected to an appropriate one of the network of servers based upon a user location.

The above description discusses embodiments of the invention with reference to a single user for clarity. It will be understood that in practice the system may be shared by a plurality of users, and possibly by a very large number of users simultaneously.

The embodiments described above are fully automatic. In some examples a user or operator of the system may manually instruct some steps of the method to be carried out.

In the described embodiments of the invention the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a embodiments is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

What is claimed is:

1. A method of providing Earth observation data comprising:
acquiring Earth observation echo data on a first satellite in a low Earth orbit,
determining a time required to downlink predetermined data to a ground station on Earth from the first satellite at a current position of the first satellite,
transmitting the predetermined data to a second satellite in orbit above Earth using space-to-space radio communication, if the time required exceeds a predetermined threshold.

2. The method of claim 1, wherein the second satellite is in a medium or higher Earth orbit.

3. The method of claim 1, wherein the second satellite is in a low Earth orbit.

4. A method of providing Earth observation data comprising:
acquiring Earth observation echo data on a first satellite in a low Earth orbit,
determining a time required to downlink predetermined data to a ground station on Earth from the first satellite at the current position of the first satellite,
receiving data relating to a current position of a second satellite in orbit above Earth,
determining a time required to downlink the predetermined data to a ground station via the other satellite at a current position of the second satellite,
if the determined time for the other satellite is less than the time determined for the first satellite, transmitting the predetermined data to the second satellite in orbit above Earth using space-to-space radio communication.

5. The method of claim 4 comprising:
receiving data relating to current positions of a plurality of other satellites in low earth orbit, and selecting one of the plurality of other satellites as a candidate for the transmitting.

6. The method of claim 1, wherein the predetermined data comprises at least a portion of the acquired echo data.

7. The method of claim 1, wherein the echo data comprises radar echo data.

8. The method of claim 1, wherein the echo data is obtained from a synthetic aperture radar system.

9. The method of claim 1, wherein the echo data comprises optical echo data.

10. The method of claim 1 comprising:
processing the echo data at the satellite to generate an image;
analysing the image at the satellite to determine a portion of interest; and
transmitting a data structure comprising a location of the portion of interest as the predetermined data using the space-to-space link to another satellite.

11. (canceled)

12. The method of claim 10, wherein the portion of interest comprises at least part of an object and analysing the image comprises using an object detection algorithm to detect the object.

13. The method of claim 12, wherein the data structure comprises a characteristic, type or identity of the object.

14. The method of claim 12, comprising classifying the object.

15. The method of claim 14, comprising classifying the object using a neural network.

16. The method of claim 12, wherein the object comprises a seafaring vessel.

17. The method of claim 10, wherein the portion of interest comprises an area that has undergone a change and analysing the image comprises using a change detection algorithm to detect the change.

18. The method of claim 10, wherein the data structure comprises a snippet of the image, the snippet comprising at least part of the portion of interest.

19. The method of claim 10, comprising transmitting further data of, or derived from, the image using a direct ground station link.

20. An Earth observation satellite which implements the method according to claim 1, comprising:
sensors configured to collect the echo data;
a computing system configured to process the echo data;
a radio transmitter configured to transmit data to another satellite using a space-to-space link.

21.-24. (canceled)
